(19) United States
(12) Patent Application Publication
(10) Pub. No.: US 2014/0067621 A1
(43) Pub. Date: Mar. 6, 2014

(54) PRODUCT VERSION TRACKER

(71) Applicant: Erik Gwyn Urdang, Boulder, CO (US)

(72) Inventor: Erik Gwyn Urdang, Boulder, CO (US)

(73) Assignee: Level 3 Communications, LLC, Broomfield, CO (US)

(21) Appl. No.: 13/599,416

(22) Filed: Aug. 30, 2012

(51) Int. Cl. G06Q 30/00

(52) U.S. Cl. 705/27.1

(57) ABSTRACT

Implementations of the present disclosure involve an apparatus, system and/or method for tracking versions of a telecommunications product over time. In particular, the product version tracker maintains the one or more network components that comprise the various versions of the product, as well as the connection scheme of the components to create the product. The product version tracker stores the versions of the telecommunications product in a database. In addition, the product version tracker may include a user interface, typically accessed through a computing system, to provide a visual representation of the stored versions of the products to an administrator of the telecommunications network.

### TECHNICAL FIELD

Aspects of the present disclosure relate to telecommunication networks. More particularly, aspects of the present disclosure involve an apparatus, system and/or method for storing instances of available products of a telecommunications network as versions of the products vary over time for utilization by a network administrator.

### BACKGROUND

A communication network typically employs numerous network elements for exchanging data across the network for delivery to a final destination. For example, within a typical telecommunications network, numerous types of network elements from many different vendors are interconnected with each other in very complex configurations. In addition, customer networks within the communication network often utilize several various such network elements to comprise the customer networks. Thus, identifying and maintaining a database representing the configuration of the network is important in managing the complex telecommunications network.

To facilitate matching the telecommunications needs of a potential customer with the features available in the network, telecommunication companies often offer packages or groups comprising several network elements as a single product. For example, a potential customer may request local and long distance voice communication capabilities for a commercial building. However, such capabilities require several components of a telecommunications network to facilitate, including both network elements local to the commercial building and network elements located a distance from the commercial building. For ease of use, such components may be grouped and sold as a single product to the customer. Similarly, other network capabilities such as data services (content delivery networks (CDN), internet service, virtual private networks (VPN)), video services and/or communication bandwidth can also be grouped into products and sold to customers to meet the telecommunication needs of those customers.

As new and faster network components become available, the group of components that comprise a product offered by the telecommunications network may change. For example, a newly developed router may be integrated into a video service product offered by the telecommunications company to replace one or more routers with less bandwidth. As such, the products offered by the telecommunications company may go through various versions of the product as faster and better telecommunications components become available. Over time, several versions of a product may be offered by the telecommunications company such that a first version of the product is sold to a customer while a later version of the same product is sold to another customer.

The existence of different versions of the same product deployed on the telecommunications network may cause complications when managing the telecommunications network. For example, an administrator of the network may receive a request from a customer to upgrade a service, such as adding additional bandwidth. However, depending on when the product was purchased, the version sold to the customer may be different than the current version of the product. Thus, the upgrading of the product for the customer may include several additional steps to identify the network components commissioned to the customer as such components may no longer be available in the product at issue. The addition of several steps to perform such maintenance on the telecommunications network is a waste of network resources.

Hence, among other things, there exists a need for systems and methods for maintaining the various versions of a product offered by a telecommunications network over time such that the versions may be referenced by an administrator of the network. In addition, there further exists a need for systems and methods for maintaining which version of a product was purchased by a customer to aid in maintenance and upgrading of the customer's product.

### SUMMARY

One implementation of the present disclosure may take the form of a method for maintaining information of a telecommunications network. The method may include the operations of obtaining information for a first new product comprising a plurality of telecommunication devices, the information for the first new product comprising at least a first list of the plurality of telecommunication devices and a first description of at least one connection between the plurality of telecommunication devices and comparing the information for the first new product to at least one entry in a product catalogue database configured to store a list of telecommunications products. In addition, the method may include the operations of creating a product version entry in the product catalogue database, the product version entry comprising the information for the first new product and an indicator indicating that the product version entry is a version of the at least one entry in the product catalogue database and displaying the product version entry in a user interface on a computing device.

Another implementation of the present disclosure may take the form of a system for maintaining information of a telecommunications network. The system may include a database configured to store topology information for a telecommunications network, the topology information comprising an identification of at least one deployed network element, a display device, a processor and a computer-readable device associated with the processor. One or more instructions may be stored on the computer-readable device that are executed by the processor to obtain information for a customer configured product comprising a plurality of telecommunication devices, the information for the customer configured product comprising at least a first list of the plurality of telecommunication devices and a first description of at least one connection between the plurality of telecommunication devices and create a customer configured product entry in the database, the customer configured product entry comprising the information for the customer configured product and an indicator indicating the customer associated with the customer configured product entry. The one or more instructions may also, when executed, compare the information for the customer configured product to at least one existing entry in the database associated with the customer and display the information for a customer configured product in a user interface on the display device.

### BRIEF DESCRIPTION OF THE DRAWINGS

FIG. 1 is a diagram illustrating an exemplary telecommunications network including network elements that may be included in various versions of products offered by a telecommunications company.

FIG. 2 is a block diagram illustrating an exemplary product version tracker of a telecommunications network that maintains the various versions of the one or more products offered by a telecommunications company.

FIG. 3 is a diagram illustrating the various versions of a telecommunications product over time.

FIGS. 4A-4C are diagrams illustrating one embodiment of a user interface illustrating versions of a product, and the components of each version of the product, offered by a telecommunications network over a particular time frame.

FIG. 5 is a flowchart illustrating a method for maintaining the versions of a telecommunications product over time.

FIG. 6 is a block diagram illustrating an exemplary arrangement for utilizing a network topology discovery engine to identify one or more network elements of a telecommunications network.

FIG. 7 is a flowchart illustrating a first embodiment of a network topology discovering algorithm that may be utilized by a network topology discovery engine.

FIG. 8 is a flowchart illustrating a second embodiment of a network topology discovering algorithm that may be utilized by a network topology discovery engine.

FIG. 9 is a block diagram illustrating an example of a computer system which may be used in implementing embodiments of the present disclosure.

### DETAILED DESCRIPTION

Implementations of the present disclosure involve an apparatus, system and/or method for tracking versions of a telecommunications product over time. In particular, the product version tracker maintains the one or more network components that comprise the various versions of the product, as well as the connection scheme of the components to create the product. The product version tracker stores the versions of the telecommunications product in a database. In addition, the product version tracker may include a user interface, typically accessed through a computing system, to provide a visual representation of the stored versions of the products to an administrator of the telecommunications network.

Further still, the product version tracker may maintain versions of products purchased for a particular customer. For example, telecommunication products may be customizable within certain parameters to meet the needs of a particular customer, such as providing different available bandwidth from one customer to the next within the same purchased product. Thus, the portion of the telecommunications network reserved for a particular customer as a result of purchasing the product may vary from one customer to the next. The product version tracker of the present disclosure may maintain the components utilized, the connection between the components and any other information particular to that product purchase in a database for reference by the network administrator. Thus, in addition to maintaining the various product versions offered, the product version tracker may also maintain the particular deployment of purchased product for each customer. Such information may be utilized by the network administrator to maintain and/or upgrade the telecommunications network.

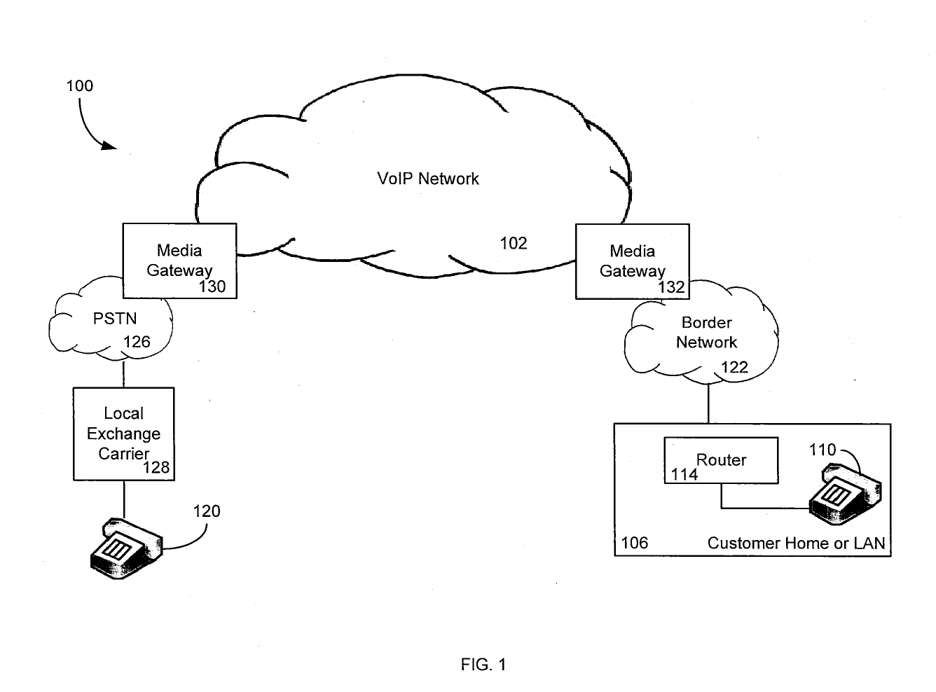

FIG. 1 illustrates an exemplary operating environment 100 for implementing a product version tracker. The environment 100 provides for setting up communication sessions, such as a Voice over Internet Protocol (VoIP) communication session, between network users. With specific reference to FIG. 1, the environment 100 includes a telecommunications network 102 provided by a wholesale network service provider. The telecommunications network 102 includes numerous components such as, but not limited to, Voice Over Internet Protocol (VOIP) components such as gateways, routers, registrars and/or one or more Synchronous Optical Network (SONET) components such as switches, add-drop multiplexers and/or digital cross-connect systems, which enable communication across the telecommunications network 102, but are not shown or described in detail here because those skilled in the art will readily understand these components. Also relevant to this description is the interaction and communication between the telecommunications network 102 and other entities, such as the one or more customer home or business local area networks (LANs) 106.

Customer network 106 can include communication devices such as, but not limited to, a personal computer or a telephone 110 connected to a router/firewall 114. The communication and networking components of the customer network 106 enable a user at the customer network 106 to communicate via the telecommunications network 102 to other communication devices, such as another customer network and/or an analog telephone 120. Components of the customer network 106 are typically home- or business-based, but they can be relocated and may be designed for easy portability. For example, the telephone 110 may be wireless (e.g., cellular).

The customer network 106 may connect to the telecommunications network 102 via a border network 122, such as an Internet Service Provider (ISP). The border network 122 is typically provided and maintained by a business or organization such as a local telephone company or cable company. The border network 122 may provide network/communication-related services to their customers. The analog telephone 120 accesses, and is accessed by, the telecommunications network 102 via a public switched telephone network (PSTN) 126 and a local exchange carrier (LEC) 128. Communication via any of the networks can be wired, wireless, or any combination thereof. Additionally, the border network 122 and PSTN 126 may communicate, in some embodiments, with the telecommunications network 102 through a media gateway device (130, 132).

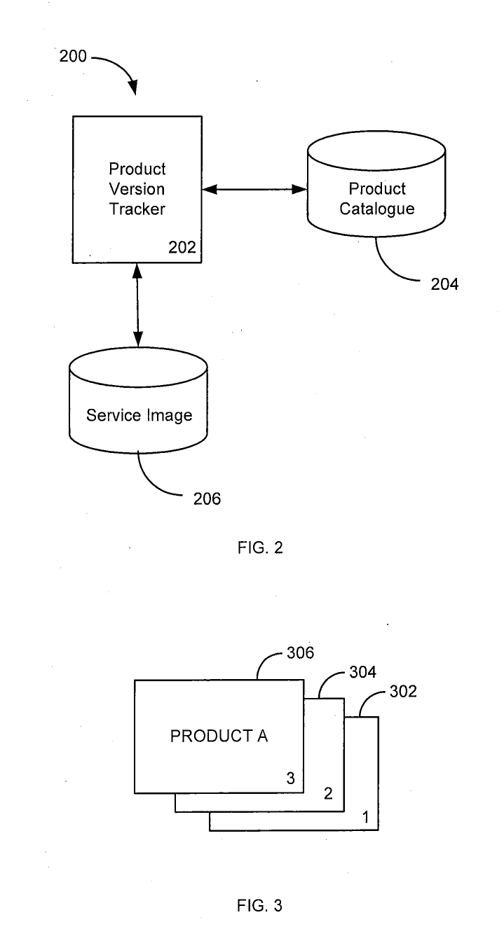

FIG. 2 is a block diagram illustrating an exemplary product version tracker 202 of a telecommunications network that maintains the various versions of the one or more products offered by a telecommunications company. In general, the product version tracker 202 may be a program that obtains and/or stores various versions of products offered by a telecommunication company over time, including the components that comprise the products and the connection between the components. Additionally, the product version tracker 202 may also store particular instances of sold products and associate those instances with a customer. The customer specific instance of the sold products may include the components of the product and the particular connection scheme for that particular customer. Further still, the product version tracker 202 may include a user interface that represents the versions of the products and/or the customer-specific instances of the products for reference by an administrator of the telecommunications network.

The product version tracker 202 is connected to or otherwise in communication with at least one database containing information of a telecommunications network. In particular, the product version tracker 702 of FIG. 2 communicates with a database containing a product catalogue 204 and a database containing a representation of the telecommunications network 206, referred to herein as a service image. Although depicted in FIG. 2 as separate databases, it should be appreciated that the information in the databases may be in a single database. Exemplary functions of the product version tracker 202 are described in further detail below. In general, the product version tracker 202 may be implemented in one or more general-purpose or special-purpose computing devices.

In general, the product catalogue 204 maintains the various versions of the products offered by a telecommunications company over time. For example, as explained above, a telecommunications company may offer several types of products to customers, such as data services, video services, voice communication and/or available telecommunications products, such as dark optical fiber. Thus, the product catalogue database 204 maintains a list of each of the available products offered by the telecommunications company. In addition, one or more of the offered products may include a plurality of network elements connected in a particular manner. As such, the product catalogue database 204 also stores a list of each network component included in the offered products, as well as a description of a typical connection scheme for the components of a product to provide the capabilities of the product. Other information concerning the products and/or the products that comprise the products may also be stored, such as the bandwidth available for each product, the cost of each product, and the like.

Further, as also discussed above, the products offered by a telecommunications company can vary over time as additional or better network components become available. For example, a router with a larger bandwidth that consumes less energy may become available after a product is offered. In response, the telecommunications company may decide to include the new router as a portion of the product, requiring the description of the product in the product catalogue database 202 to be altered to reflect the newly added network device. This new instance of the product that includes the new network device is referred to as a new version of the product. In addition, the connection information may also be updated in the product description to account for any new connections that may accompany the newly added device.

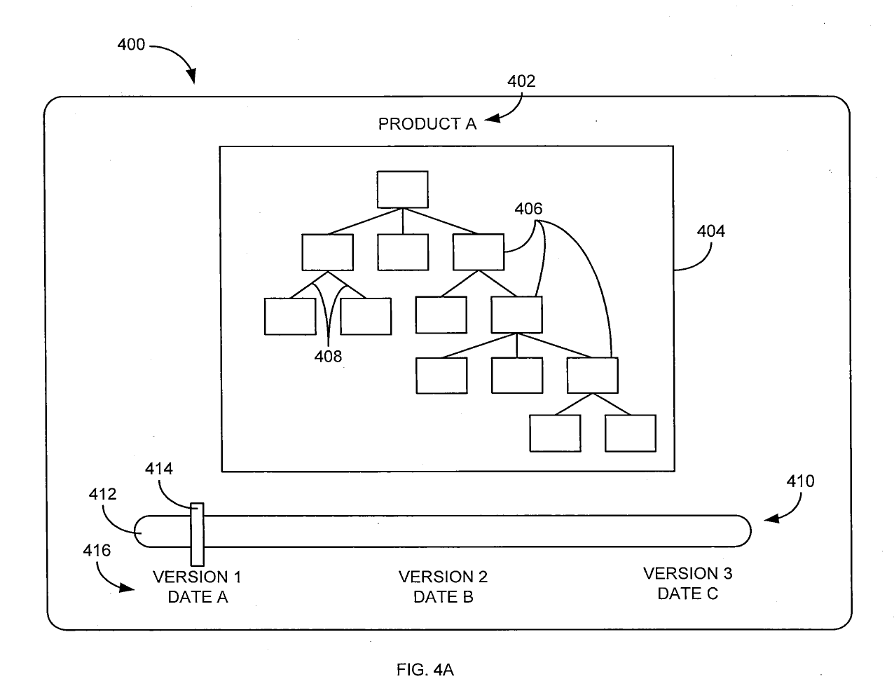

FIG. 3 is an example illustrating the various versions of a telecommunications product over time. In particular, FIG. 3 illustrates three versions of an exemplary product of a telecommunications network, illustrated at “Product A”. Thus, Product A has a first version 302, a second version 304 and a third version 306. In general, each version of the product includes some change from a previous version, either in the components that comprise the product or the connection scheme for each product. As such, the second version 304 of Product A includes a new network component as part of the product, removes a network component, replaces a network component with another network component, alters one or more connections between the components, provides more capabilities for the product (such as additional bandwidth, video services, conference calling, etc.) and the like in comparison to the first version 302 of the product. Similarly, the third version 306 of Product A includes some alteration to the product description when compared to the second version 304. The information describing the different versions 302-306 of Product A are stored in the product catalogue database 202 of FIG. 2. In one embodiment, the various versions of the products are stored in the product catalogue 204 manually as new versions and products are developed. In another embodiment, the new versions and products are obtained or provided to the product version tracker 202 which then stores the new versions and products in the product catalogue database 204.

In one embodiment, a description of the entire product is stored in the product catalogue database 202. Thus, each version of the product includes an entire list of the components, connections and capabilities of the product. In another embodiment, the differences between one version and the next is stored in the database 202. Thus, the first version of the product includes the entire list of components, connections and capabilities. Subsequent versions of the product stored in the product catalogue database 202 may include only those changes made to the overall description to create a new version. In yet another embodiment, the product catalogue database 202 stores an entire new instance, the changes from version to version, and/or a combination of both.

Returning to FIG. 2, the product version tracker 202 is also connected to service image database 206. The service image database 206 stores, among other things, particular instances of sold products associated with a client. As mentioned above, some products sold by a telecommunications company may be configurable to provide different parameters of the product. For example, a data service product may be offered with various bandwidths, such as 1 MB, 5 MB or 10 MB. As a result of the bandwidth selected by the customer, the product provided to the customer may include more or fewer connections and/or network elements. The particular instance or configuration of a product that is purchased and deployed on the telecommunications network for that client is then stored in the service image database 206 for reference by the product version tracker 202. In other words, the information stored in the service image database 206 describes one or more specific products sold and the customer to which the product was sold, while the information stored in the product catalogue is a general description of the products, and the various versions of those products, offered by the telecommunication network over time. In one embodiment, the service image is entered into the service image database 206 manually upon installation of a product for a particular customer. In another embodiment, the information is obtained by the product version tracker 202 and stored in the database by the product version tracker. In yet another embodiment, described in more detail below, the service image database 206 is updated automatically by a topology discovery engine of the telecommunications network.

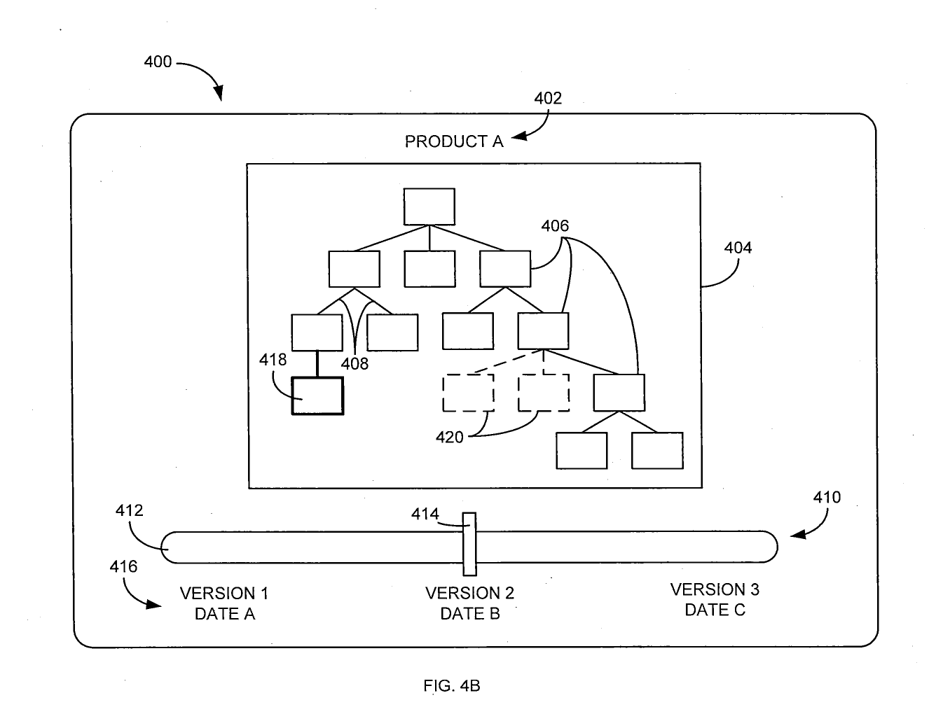

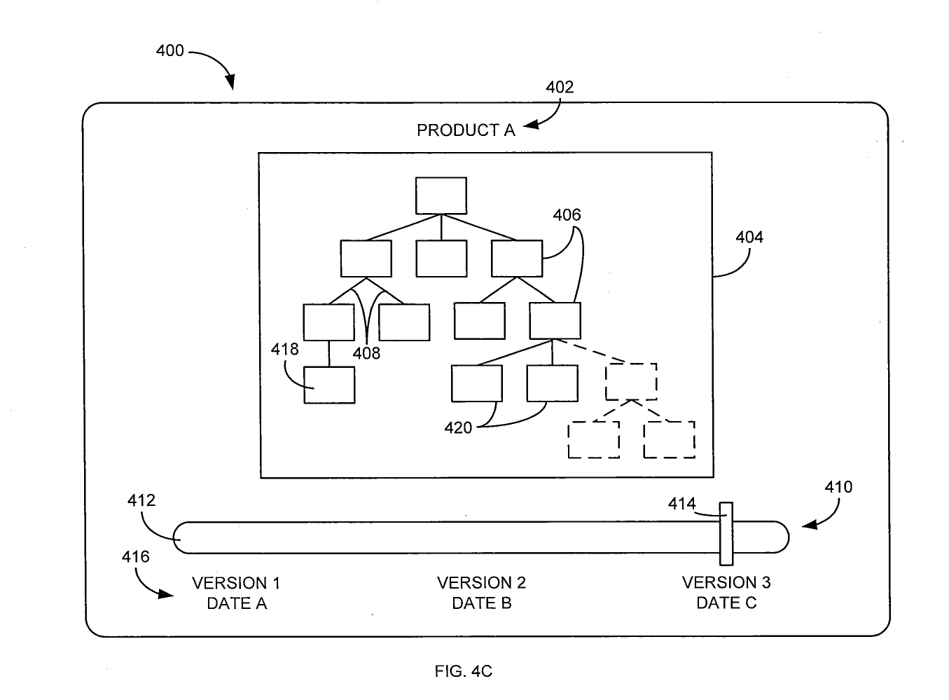

The product version tracker 202 utilizes the databases 204, 206 to maintain the one or more network components that comprise the various versions of the products of the telecommunications network, as well as the connection scheme of the components to create the product. Also, the product version tracker 202 also utilizes the databases 204, 206 to maintain specific instances of sold products and associates those specific instances with one or more customers of the telecommunications network. In addition, the information maintained by the product version tracker 202 may be accessed or otherwise provided to a network administrator for use in updating or analyzing the telecommunications network. In one embodiment, the product version tracker 202 includes a user interface, typically accessed through a computing system, to provide a visual representation of the stored versions of the products to an administrator of the telecommunications network. One example of such a user interface is illustrated in FIGS. 4A-4C, discussed in more detail below.

As shown in FIG. 4A, the user interface 400 includes a title field 402 for the product being illustrated in the user interface. In this example, exemplary Product A is being illustrated. The user interface 400 also includes a visual representation 404 of the product. In the visual representation 404 of the product shown in FIG. 4A includes one or more boxes 406 that represent the network elements that comprise the product. For example, one of the boxes 406 may represent a router included in the product, while another box may represent a telephone device. In general, the boxes 406 illustrated in the visual representation 404 may be any network device, any collection of network device, or any portion of a network device utilized to provide the capabilities of the displayed product.

The visual representation 404 also includes one or more illustrated connections 408 between the components 406 of the product. In general, the connections 408 shown in the visual representation 404 illustrate communication connections between the components 406 of the product. For example, to provide voice communication services to a customer, several of the components 406 of the product are connected to carry the voice traffic from the local devices to the telecommunications backbone. Thus, the connections 408 illustrated in the visual representation 404 display the connections between the components 406 of the product to facilitate the capabilities of the product. Further, although not shown in FIG. 4A for simplicity, the components may be inter-connected among many other components of the product and/or may include several connections between the components. Those of skill in the art will recognize the many ways in which components of a product can be inter-connected to facilitate the capabilities of the products.

Although the visual representation 404 of the product shown in the user interface 400 of FIG. 4A includes the boxes 406 and connections 408 described above, such representation is but one example of the type of visual representation of the components of the product. In general, any representation of the components and connections of the product may be illustrated in the user interface 400. For example, the visual representation 404 may include a simple list of each included component and the connection scheme to facilitate the capabilities of the product. In another example, the visual representation 404 may include a spreadsheet or graph illustrating the components and the connections. Further, the visual representation 404 may include a combination of the various methods to illustrate the components of the product. For example, the visual representation 404 of FIG. 4A may include a feature that allows a user to click on a component box 406 to obtain a list of the component specification and/or the specific connections to and from the component. In this manner, the graphical representation of the product can be merged with a list of the component details to provide more information to the user. In general, any manner by which the components of the product and the connections between the components may be shown in the visual representation 404 of the product in the user interface 400.

The user interface 400 may also include a user-controllable selection interface 410. In the embodiment illustrated in FIG. 4A, the user-controllable selection interface 410 is a slider bar 412 that can be manipulated by a user of the user interface, such as by selecting and moving the slider 414 of the slider bar with a mouse or other computer input device. In general, the user-controllable selection interface 410 allows the user to select between the various versions of a product. Thus, in the example of FIG. 4A, positions of the slider 414 along the slider bar 412 indicate which version of the product is being displayed in the graphical representation window 404. In addition, the positions on the slider bar 412 are arranged such that the earliest version of the product is located on the left side of the slider bar and the most recent version is on the right side of the bar. Locations to access the versions of the product between the earliest version and the latest version are arranged along the middle of the slider bar 412. Further, each position along the slider bar 412 includes a version information section 416 that displays the version date or other indicator of when the version was entered into the product catalogue database 204. In general, any information concerning the various versions included on the slider bar 412 may be included in the information section 416, including version numbers, version names, identification numbers of the versions and the like.

Although shown as a slider bar configuration 412 in FIG. 4A, the user-controllable selection interface 410 may take any form that provides for the user to select among the various versions of a product. For example, the user-controllable selection interface 410 may take the form of a drop-down menu, a selectable list of the versions, a group of icons and the like that provides an interface through which a user can use an input device to a computer to select from the various versions of the illustrated product.

As mentioned above, the user may utilize the user-controllable selection interface 410 to display the versions of the product. For example, FIG. 4B illustrates the second version of Product A of FIG. 4A. Thus, the user interface components, such as the title field 402, the visual representation window 404, the user-controllable selection interface 410 and the version information section 416 are similar to those shown in FIG. 4A. Further, as illustrated, the slider 414 of the slider bar interface 412 is located at the “Version 2” position such that the second version of the product is shown in the visual representation window 404. The slider 414 is moved to the “Version 2” position by a user of the user interface 400 through one or more input devices to select the “Version 2” position and display the second version of the product. Further, a date or release or additional information associated with the second version may be included in the information section 416 associated with the second version.

As mentioned above, different versions of a product may include fewer or more components and/or more or fewer connections between the components to provide the capabilities of the versions. This variation in the composition of the different versions of the product may be illustrated in the visual representation window 404 to illustrate the changes from one version to the next. For example, as shown in FIG. 4B, the visual representation 404 of the product version is provided in the user interface. However, the representation of the second version of the product is different than the representation of the first version shown in FIG. 4A. In particular, the second version includes an additional network component 418 and associated connection to a component of the product. In addition, the second version of Product A also removes components 420 and the associated connections. In one example, the additional network component 418 may have the capabilities of the removed components 420 such that the removed components are no longer needed in the product. In any event, the visual representation 404 of the product illustrates the components and connections of the second version.

Additionally, the visual representation 404 of the second version may visually illustrate the changes from the first version to the second version. For example and as shown in FIG. 4B, added components 418 and connections are shown in bold while removed components 420 and connections are shown as dashed lines. In this manner, the changes from one version to the next can be quickly determined by a user of the user interface through the visual representation 404 of the product version. Although shown in FIG. 4B through bolding and dashed lines, the changes from version to version may be expressed in any visual manner. For example, the changes may be expressed by providing such changes in an assigned color, such as blue for added components and red for removed components. In another example, the changed components may flash or otherwise be animated to indicate the component is added or removed from the previous version. In yet another example, the changes may include any of the above, such as colored dashed lines to indicate the change. In general, any visual effect that highlights or indicates a component or connection as being changed from the previous version may be used in the visual representation 404 of the product version.

In another embodiment of the user interface 400 may not show any changes from the previous version. Thus, in this embodiment, the selected version of the product is shown in the visual representation window 404 without any indicators of the changes from the previous version. In another embodiment, the user interface 400 may only provide the changes such that the visual representation 404 displays the changes from the previous version of the product without the components and connections that are similar from the previous product.

In a similar manner, a third version of the product may be accessed through the user-controllable selection interface 410. Thus, as shown in FIG. 4C, a third version of Product A is shown in the user interface 400, including the changes in the composition of the product in relation to the second version of the product shown in FIG. 4B. The third version of the product shown in FIG. 4C may be accessed by the user by dragging the slider 414 of the slide bar 412 to the indicator for “Version 3”. The third version may be the current version of Product A offered by the telecommunications company as stored in the product catalogue database. As shown, several of the components of the product may be removed from the product from the second version to the third version. Such removal of components may be possible as the telecommunications network becomes more efficient and less components of the product are needed to provide the same functionality.

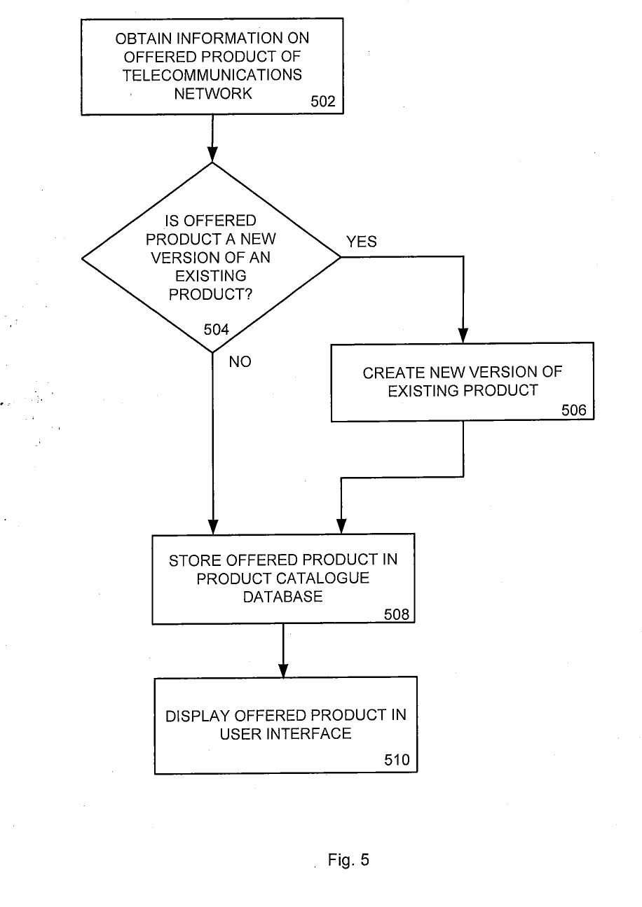

FIG. 5 is a flowchart illustrating a method for maintaining the versions of a telecommunications product over time. The operations of the method of FIG. 5 may be performed by the product version tracker 202 described above. In particular, the product version tracker 202 may include one or more computer-readable instructions that, when performed by a processor of a general or special purpose computer, performs the operations of the flowchart of FIG. 5.

Beginning in operation 502, the product version tracker 202 obtains information on a product offered by a telecommunications company. The offered product may be a new product or may be a new version of an existing product offered by the telecommunications company. The information on the offered product may be provided to the product version tracker 202 from the telecommunications company, either manually or electronically. Alternatively, the product version tracker 202 may be configured to request such information from a database or set of databases to obtain the information.

In operation 504, the product version tracker 202 determines if the offered product is a new product or a new version of an existing product. Identification of the product as a new product or a new version of an existing product may be performed in any manner. For example, the offered product may have the same name as a previously offered product, indicating that the offered product being analyzed is a new version of an existing product. In another example, the offered product may include a serial number that is similar to or sequential to a serial number of an existing product such that the offered product is a new version of an existing product. In general, the telecommunications company may identify or categorize the products in a product catalogue as desired to differentiate between the products. Thus, in operation 504, the product version tracker 202 is configured to analyze any information associated with the offered product to determine whether the offered product is a new product or a new version of an existing product.

If the product version tracker 202 determines that the offered product is a new version of an existing product, the product version tracker creates a new version of an existing product in operation 506. The created new version may include some components and/or connections of the existing product, with some indication of any newly added or removed components or connections. Alternatively, the created new version may only include the differences from the previous version of the product or a combination of either. Upon creation of the information describing the new version of the product, the information is stored in the product catalogue database 204 in operation 508. However, if the product version tracker 202 determines that the offered product is a new product in operation 504, the new product is stored in the product catalogue database 204 in operation 508.

In operation 510, the information stored in the product catalogue database 204 is displayed in a user interface 400 to an administrator of the telecommunications network. In this manner, the various versions of the products offered by a telecommunications network are available to an administrator of the network for maintenance and upgrading of the network.

Returning to FIGS. 4A-4C, the product version tracker 202 may also provide version information specific to a particular customer or instance of a sold product. Thus, the information provided in the user interface 400 of FIGS. 4A-4C may be configured to display a particular instance of a deployed product in the visual representation window 404 rather than an offered product. In addition, the user interface 400 may provide information on the changes made to a deployed product through the user interface. For example, the visual representation 404 of the product shown in FIG. 4A may be a particular instance of a sold product, including the requested components and connections to meet the needs of a customer to the network. To distinguish the shown product for a particular customer from the general available product, the title field 402 includes the product name, as well as some identifier of the product instance, such as a client name or client ID. As should be appreciated, a separate instance of the product for a different customer may include fewer or more components and/or connections. In general, the information utilized to populate the user interface 400 with the instance of the product may be stored in and accessed from a service image database.

As changes are made to a particular instance of the product, perhaps in response to a request by the particular customer of the product, new versions of the instance may be accessed through the user interface 400. Thus, the visual representation 404 of the product instance shown in FIG. 4B includes the changes to the particular instance of the product. In another embodiment, the visual representation 404 may only show the changes made without showing the existing product components and connections. In any event, the changes made to the product instance are tracked from one version of the instance to another. Further, the date of the changes made to the product instance for that client is indicated in the information section 416 of the user interface 400. Other changes made to the product instance may be shown in additional user interface 400 screens, such as that illustrated in FIG. 4C. In general, the operations of the user interface 400 is similar to that described above, except the illustrated product 404 is that of a particular instance of the product, perhaps associated with a particular client.

The information used to populate the data of the user interface 400 to illustrate the various versions of an instance of a deployed product may, in one embodiment, be gathered from a service image database by the product version tracker 202. In one embodiment, the information in the service image database is populated by a network topology discovery engine, described in greater detail below. In general, the network topology discovery engine communicates with a telecommunications network to detect one or more network elements and/or one or more connections between a plurality of network elements. To detect the network components, the network topology discovery engine transmits a request for operational and connection information from at least one addressable network element over a communication link. In response, network topology information is received by the network topology discovery engine by one or more elements of the network that provide information on the topology and operational state of the telecommunications network. The received information may then be stored in a service image database for use by the product version tracker to provide the versions of a product instance of the telecommunications network.

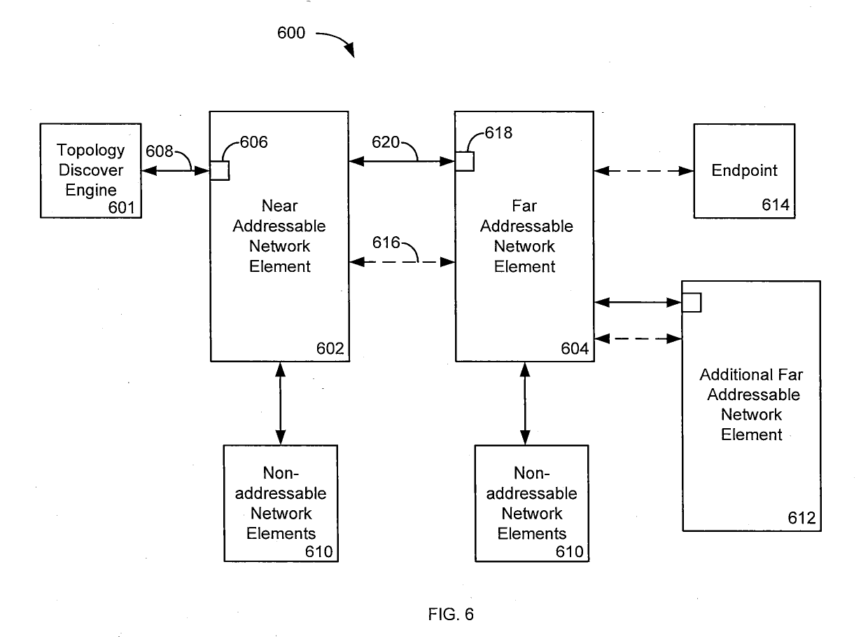

FIG. 6 is a block diagram illustrating an exemplary arrangement for utilizing a network topology discovery engine 601 to identify one or more network elements of a telecommunications network 600. The simplified arrangement is intended for illustrative purposes. In an actual operating environment, the topology discovery engine 601 would be connected to or otherwise in communication with numerous network elements, which themselves would be connected to numerous other network elements in various configurations.

The arrangement of FIG. 6 includes a near network element 602 and a far network element 604. As used herein, the terms “far” and “near” are used in a logical, rather than physical, sense. Thus, the far network element 604 is not necessarily physically farther from the topology discovery engine 601 than the near network element 602. Rather, the near network element 602 is at a known address; i.e., the topology discovery engine 601 can readily communicate with the near network element to obtain information about the identity, configuration, and/or operating parameters of the near network element 602, as well as information for one or more network elements connected to or otherwise in communication with the near network element. Characteristics of the far network element 604, such as type, model, communication address and operating parameters, may not be known to the topology discovery engine 601 prior to topology discovery. Operations performed by the topology discovery engine 601 to obtain the information about the near network element 602, the far network element 604 and any other network element of the telecommunications network 600 are discussed in more detail below.

To communicate with the near network element 602, the topology discovery engine 601 is in communication with an addressable communication port 606 associated with the near network element 602. The communication port 606 may be any communication port that is identifiable and accessible by an address. For example, the communication port 606 may be an external interface, such as Ethernet, which enables communications between the topology discovery engine 601 and the near network element 602. In another example, the communication port 606 may be a wireless communication port. In general, each addressable network element of the telecommunications network 600 includes some communication port over which communication with the element may occur.

Communication between the topology discovery engine 601 and the near network element 602, shown in FIG. 6 by communication arrow 608, may occur over many types of networks and communication types. For example, the communication 608 may occur within the telecommunications network in which the near network element 602 operates, may occur out of the network, or may occur both in-network and out-of-network. In another example, the communication may originate as a wireless communication, such as over a satellite, from the topology discovery engine 601 that is then received by and transmitted through a wired network. In general, any type of electronic communication for transmitting and receiving information may be utilized for communication between the topology discovery engine 601 and the near network element 602.

One or more non-addressable network elements 610 are also connected to the near network element 602. Non-addressable network elements 610 may include those elements of a telecommunications network that may not be directly communicated with through an addressable port. For example, one or more fiber optic cables may be connected to the near network element 610 to carry communications through the network. Other elements may be integral to the near network element 610 but are otherwise unaddressable. For example, the near network element 610 may include a power supply, laser components, communications ports, etc. that are utilized during operation of the element. However, these components of the near network element 602 are typically non-addressable such that information about the operation of these components is not available directly from the components themselves. As explained in more details below, information concerning the non-addressable network elements 610 connected to or otherwise associated with the near network element 602 may be gathered by the near network element in response to a request by the topology discovery engine 601.

Also connected to the near network element 602 are one or more far network elements 604. The characteristics of the far network element 604 may be similar to the near network element 602 such that the far network element may include an addressable communication port 618 that receives communications 620 from the near addressable network element, another network element, the topology discovery engine or any other computer-type device associated with the network. In addition, several communication lines 616 may connect the near network element 602 with the far network element 604 to carry network communications and create a portion of the telecommunications network. Additional far network elements 612 may also be connected to the far network element 604 in a similar manner. The connection of these elements in a manner that provides for the transmission of communications from one element to the next form the telecommunications network.

In addition to the communication connections between the elements that carry the traffic of the telecommunications network, information connections 620 may also be present such that topology and operational information may be transmitted between the elements. As such, the near network element 602 may request and receive operational and topology information from the far network element 604 apart from the communication traffic carried by the elements. Similarly, the far network element 604 may request and receive operational and topology information from the additional far network elements 612. In this manner, topology and operational information may be requested and received at the topology discovery engine 601 from the network elements of the telecommunications network.

In one embodiment, an endpoint 614, such as a local carrier or user's computer, for a communication being transmitted through the network may be connected to the far network element 604. As such, the network elements depicted in FIG. 6 form one or more paths for the communications carried by the telecommunications network. Also, one or more unaddressable network elements 610, similar to the unaddressable network elements described above, may be connected to the far network element 604 and/or the additional far network elements (not shown).

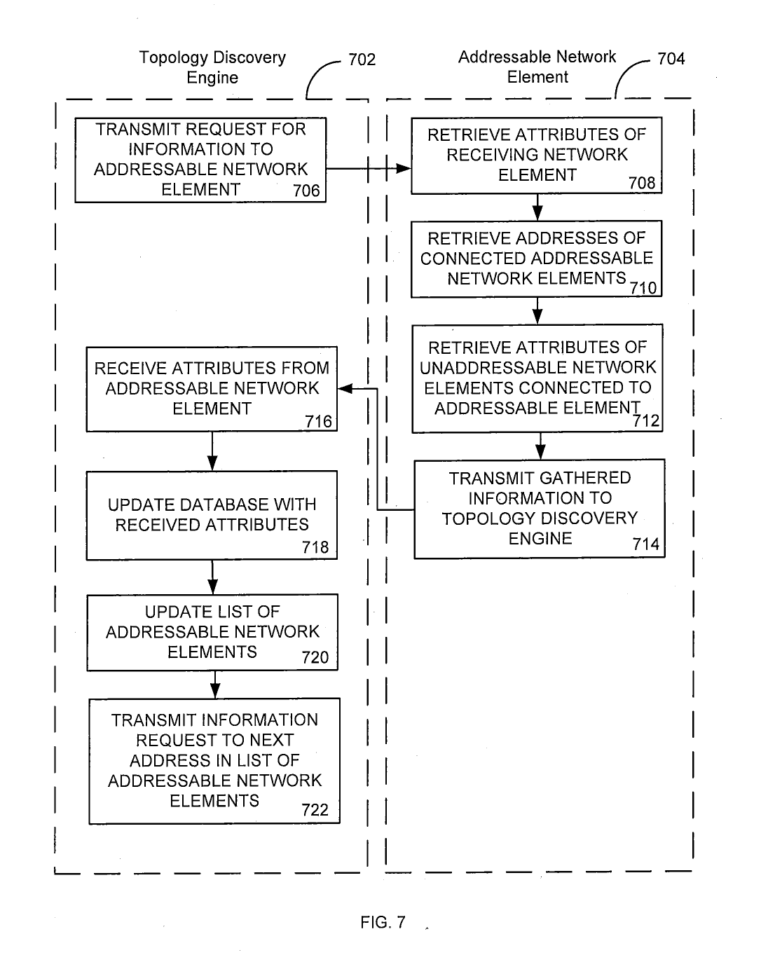

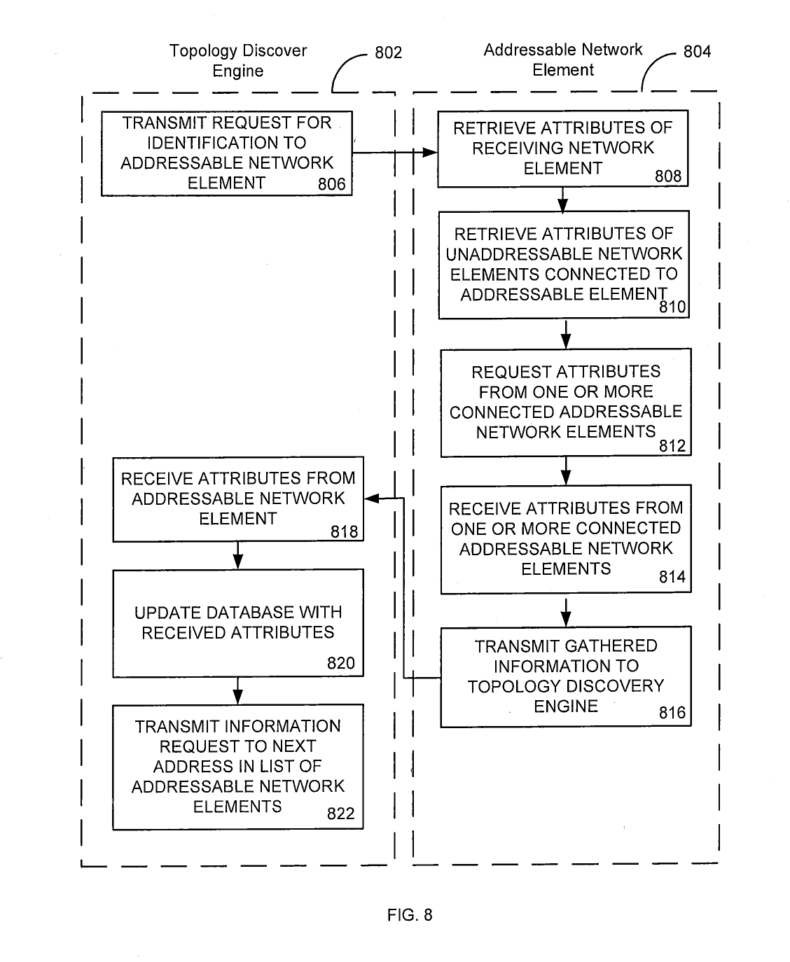

Through the configurations above, a network topology discovery engine may communicate with one or more elements of a telecommunications network to request and receive information on the network to create a database describing the topology of the network. FIG. 7 is a flowchart illustrating a first embodiment of a network topology discovering algorithm that may be utilized by a network topology discovery engine. The operations of the method of FIG. 7 are discussed in relation to the configuration shown in FIG. 6. However, those of ordinary skill in the art will recognize that many other configurations exist that allow the network topology discovery engine to communicate with one or more network elements to receive information about the network. In general, any set-up for exchanging information between the topology discovery engine and the network elements may utilize the operations described below to discover the topology of a telecommunications network.

The operations illustrated in FIG. 7 are performed by the topology discovery engine and at least one addressable network element. In particular, the operations shown in dashed box 702 are performed by the topology discovery engine and the operations shown in dashed box 704 are performed by an addressable network element. Communication between the operations of boxes 702 and 704 occur over communication line 608 of FIG. 6.

Beginning in operation 706, the topology discovery engine 601 transmits a request for certain information to an addressable network element. The request may take any form that is recognizable by the addressable network element. For example, the request may take the form of an Extensible Markup Language (XML) query transmitted to an IP address associated with the network element. The XML request may include requests for particular types of information that, when received, is populated by the addressable network element. As such, the request for information may be tailored for specific topology or operational information concerning the network element. In another example, the request may take the form of a Windows Management Instruction (WMI) request. In general, any computer instruction or format that provides for the request of information from a computing device may be used in operation 706.

As discussed above, the topology discovery engine may transmit the request over any communication format to the addressable network element, including both wired and/or wireless formats. In addition, the topology discovery engine may obtain the address of the addressable network element from a list of such network elements in a database. To begin the network topology discovery, the topology discovery engine may select an address from the list, such as the first address in the list, and transmit the request to that address. In one embodiment, the lists of network element addresses stored in the database may be further divided into categories or types. For example, the database may maintain a list of addressable network elements for a particular client of the telecommunications network. In this example, the portion of the telecommunications that is utilized by the particular client may be discovered by accessing the list of network element addresses assigned to that client and transmitting one or more requests for information, such as in operation 706. In another example, the database may maintain a list of addressable network elements of a particular type, such as all-known routers of the network. In yet another example, the list of addressable network elements may be stored based on geographic location. In general, the lists of network element addresses may be divided into any categories that may be useful to an administrator of the telecommunications network for maintenance and performance analysis of the network.

Regardless of how the network element address is determined, the transmitted request is received by the near network element 602 in operation 708 and the network element begins obtaining the requested information. In particular, the near network element 602 retrieves one or more attributes concerning the operational state and/or identification information for the network element. Such information may include the type of device, including vendor and serial number, loaded software version number, operational state (such as active, fault, warning, etc.), the average power consumed, the provisioned and available bandwidth, time since last failure, component health, and the like. It should be appreciated that the list of information provided above is for example only and those of ordinary skill in the art will recognize the numerous types of information that may be gathered by the network element upon receiving the request. Further, the types of information retrieved in operation 708 may be dependent on the types of information requested by the topology discovery engine in the request.

In operation 710, the near addressable network element 602 that receives the request for information determines and retrieves the addresses for far network elements 604 connected to the near addressable network element. As explained above, the telecommunications network 600 may include hundreds to thousands of elements interconnected to provide a path for communications. Thus, a near network element (such as element 602 of FIG. 6) is connected to a far network element (element 604) in some configuration to facilitate the transmission of communications through the network. In addition, the near network element 602 may also be connected to additional far addressable network elements as the telecommunications network grows. As such, to transmit communications to the far addressable network elements, the near network element 602 may maintain a list of such elements, in addition to a communication address for communicating with the far network elements. Thus, in operation 710, the addressable network element retrieves the addresses of those far addressable network elements connected to the near addressable network element.

In addition, the addressable network element retrieves one or more attributes for the unaddressable network elements connected to the addressable network element in operation 712. As also shown above with reference to FIG. 6, one or more unaddressable network elements 610 (such as power supplies, fiber optics and other network elements that cannot be accessed remotely) may be connected to the near addressable network element 602. Such unaddressable network elements 610 are typically managed by an addressable network element associated with element. For example, although a power supply of a router is not directly addressable, the power supply may be controlled and managed by the router. Thus, operational information, such as failures of the element, is typically received or can be obtained by an addressable network element. Thus, in operation 712, the addressable network element retrieves operational and topology information for unaddressable network elements connected to the element. For example, the addressable network element may transmit a test signal through any fiber optic cable connected to the element to detect any problems with the cables. In another example, the addressable network element may query a power supply device associated with the network element to determine proper operation of the power supply. Further, the addressable network element may maintain some type of information describing the connection of the unaddressable network elements to the addressable network element, such as a port configuration list or the like. In this manner, topology and operational information of the unaddressable network elements is retrieved by the addressable network element. The addressable network element may request such information from the unaddressable elements connected to the element, or may receive such information automatically from the unaddressable elements. Regardless of how the information is received at the addressable network element, such information is gathered by the network element in operation 714.

In operation 714, the addressable network element responds to the received in operation 708 by transmitting the information gathered in operations 708 through 712. More particularly, the addressable network element transmits to the topology discovery engine the attributes of the addressable network element, the addresses and topology information for any far addressable network element connected addressable network element and operational and topology information for any unaddressable network element associated with the addressable network element. However, the type and volume of information gathered and transmitted in operation 714 may be any type of information concerning the network elements. For example, the information may be dependent on the information requested in the request received in operation 708. For example, the received request may request only the addresses of the connected addressable network elements such that only the addresses of the connected elements are transmitted in operation 714. In general, the types and volume of information gathered and transmitted in operations 708 through 714 are configurable by the topology discovery engine.

The information transmitted by the near addressable network element in operation 714 is received at the topology discovery engine in operation 716. Such information may be transmitted on the communication link as the request was transmitted, or on a different communication link or network. Once received, the topology discovery engine may begin to update the network topology database accordingly with the received information.

In particular, in operation 718, the topology discovery engine updates the network topology database with the operational and topology information received. The information may be used to update the database 400 in several ways. For example, the database 400 may maintain a topology description of the telecommunications network, i.e., a description of the interconnectivity of the network elements as well as communication connections that carry the traffic of the network. To aid in this topology description, the topology discovery engine receives in operation 716 a description of the addressable and unaddressable network components connected to the network element, including addresses for the addressable network elements. In some instances, the received information may also include the type of connection, the bandwidth of traffic being divided among the connected elements and any empty communication ports. This information may be input into the topology database to create a topology of the network elements associated with the communicated with network element. In this manner, a topology diagram or description of the network may be built.

Further, several attributes, as discussed above, for the addressable network element may also be stored in the database in operation 718. In addition, these attributes are associated with the addressed network element in the database such that operational configurations are accessible to a computing device connected to the database. Further, the operational attributes discussed above for an unaddressable network elements connected to the addressable network element may also be associated with those elements in a similar manner. In this way, information concerning the elements of the telecommunications network is associated with the elements included in the network topology description stored in the topology database.

In operation 720, the topology discovery engine may also update a list of addressable network elements stored in the database. As discussed above, the database may include a list of addresses through which the addressable network elements of the telecommunications network are accessible. Thus, as new addresses of addressable network elements are received in operation 716, such addresses may be added to a list of network element addresses. In one embodiment, the addresses may be stored in an order of access such that new acquired addresses are stored at the end of the list. As explained more below, this list of addresses may be accessed in the order of storing to discovery the topology of the network.

As also explained above, the list of addresses of the addressable network elements may be sub-divided into lists of common configurations, such as a list of network elements included in a specific customer's network. Thus, in operation 720, several lists of addresses may be updated with the discovered addresses. For example, the addressable network element may return four addresses for network elements connected to the contacted element. However, only one of those four addresses belongs to a network element that forms a portion of the specific client's network. Thus, in addition to or apart from updating the master list of addresses, a list of addressable network elements for a specific client's network may also be updated with the address of the network element that meets the criteria for that list. Thus, the received addresses may be analyzed by the topology discovery engine to determine certain attributes of the network element associated with the received address to determine any sub-list of addresses that may be updated.

After updating the topology database, the topology discovery engine may transmit a new request to another addressable network element in the telecommunications network in operation 722. In one embodiment, the topology discovery engine may utilize at least one list of network element addresses and transmit the new request to the next address contained in the list. After transmission of the new request, the above describe operations may be repeated such that the topology discovery engine receives topology and operational information for another network element. In this manner, by working through lists of network element addresses, a portion or the entire telecommunications network can be discovered by the engine and stored in the network topology database.

As should be appreciated, not every operation discussed above in relation to FIG. 7 need to be performed for network topology to occur. Rather, one or more of the operations may occur automatically or may be skipped altogether. For example, the gathering of information in operations 708 through 712 may be performed periodically by the network elements to maintain an up-to-date database of information. Thus, upon a request for information from the topology discovery engine, the network element may respond with some or all of the stored information. Similarly, the network elements may be configured to self-report the gathered information periodically or at a set time for updating of the network topology database, without a direct request from the topology discovery engine. In addition, network topology discovery may occur at differently for different portions of the telecommunications. For example, one portion of the network may be discovered by request only, while other portions may self-report topology information periodically. In another example, the network elements may be configured to report topology information when any update or change to the element occurs.

FIG. 8 is a flowchart illustrating a second embodiment of a network topology discovering algorithm that may be utilized by a network topology discovery engine. Several of the operations of the method of FIG. 8 are similar to the operations discussed above with reference to FIG. 7. As such, reference to the description of similar operations included above is referred to below.

The method of FIG. 8 begins with the topology discovery engine transmitting a request to an addressable network element for topology and operational information in operation 806, similar to operation 706 above. Thus, the request may be specified for particular types of information about the network, or may be for all available information about the network. In operation 808, the near addressable network element receives the request and gathers operational information of the receiving network element, similar to operation 708 above. Further, similar to operation 712 above, the near addressable network element gathers topology and operational information for one or more unaddressable elements connected to the near addressable network in operation 810.

However, different from the method of FIG. 7, the near addressable network element transmits an additional request to one or more far addressable network elements in operation 812 to request topology and operational information from the one or more far addressable network elements. In one embodiment, the request transmitted by the near network element to the far network element is in the same format as the request transmitted by the topology discovery engine to the near network element. In other words, the near network element may act as a topology discovery engine for those addressable far network elements connected to the near network element. Also similar to the topology discovery engine request, the request sent by the near network element to the one or more far network elements may be tailored for specific information or may request all topology and operational information available to the far network element.

As mentioned, the near network element may transmit a request for topology and operational information from one or more far network elements connected to the near network element. In one embodiment, the near network element transmits the request to all known far addressable network elements to retrieve information from all known connected far network elements. In this manner, the near network element may gather topology information from the far network elements, relieving the topology discovery engine from requesting the information from the far network elements directly. Further, in one embodiment, the far network elements may gather topology and operational information in the same manner as described above, such that the far network element receives attribute information for the far network element, topology and operational information for any unaddressable network element connected to the far network element, and/or the addresses for any addressable network elements connected to the far network element. Such information is then transmitted to the near network element in operation 814 for storage by the near network element.

In another embodiment, the request for information may be repeated through several layers of the network. Referring again to FIG. 6, in this embodiment a request for topology information originates at the topology discovery engine 601 and is transmitted to the near network element 602. In response, the near network element 602 is configured to transmit its own request to the far addressable network element 604 to gather the requested information. Further still, the far addressable network element 604 is also configured to transmit a request to additional far addressable network elements 612 for topology and operational information for the additional far addressable network elements. Such a request for topology and operational information may cascade through any number of layers of network elements from the near addressable network element 602. Thus, the number of layers that the request for information is transmitted through the network may be configured into the network or into the request transmitted by the topology discovery engine. In addition, because each network element may communicate a request to a plurality of connected addressable network elements, the information request may branch to encompass many addressable network elements from the near network element, dependent on the topology of the network. Thus, the network topology and operational information may be gathered by any number of network elements before being transmitted to the topology discovery engine for storing in the network database.

As mentioned, the number of layers that the information request propagates through the network is configurable. For example, the request for information may be transmitted as far as the additional far network elements 612. As should be appreciated, the amount of topology and operational information that may be returned to a network element through just a few iterations of the information request through the network may be substantial. Thus, to control the amount of topology and operational information being gathered by any one network element, the request for information may be tailored to propagate through only a few layers of network elements. In another embodiment, the request is tailored to be transmitted to only those network elements that meet a certain criteria, such as network elements included in a particular customer's network or a particular type of network element. Also, to prevent the duplication of information from a network element, a token system may be utilized such that once a network element has returned information to a requesting network element, a token is set indicating that the information has been returned such that any additional requests for information are ignored for that particular set of requests.

Through this request for information cascading through the layers of the network, the near network element receives topology and operational information for a portion of the telecommunications network. As such, the near network element (as well as one or more of the far network elements) performs the functions of the topology discovery engine for a portion of the telecommunications network. In this manner, the topology of the network may be discovered with only a few requests sent from the topology discovery engine. Returning to FIG. 8, all of the information received by the near network element is transmitted to the topology discovery engine in operation 816. Upon receipt, the topology discovery engine updates the network topology database in operations 818 and 820 in a similar manner as described above with reference to FIG. 7. However, it should be appreciated that the information received in operation 818 includes much more network information as the information for several layers of network elements is included, rather than information for a single network element that occurs from the method of FIG. 7. Thus, through the use the method of FIG. 8, the network topology is discovered in less time. Upon updating the network topology database, the topology discovery engine sends an additional request to another addressable network element in operation 822. In one embodiment, the topology discovery engine may determine that information for the next addressable network element in the address list was not discovered through the cascading request described above, such as by searching for a token indicating that the information was already returned.

Through the methods described above, the topology of the telecommunications network, and more general information concerning the network, is discovered. In one embodiment, the topology discovery engine requests information from a first network element, receives information concerning that network element as well as address information for network elements connected to the first network element and adds those addresses to a list of network elements from which information is requested. In another embodiment, one or more network elements gather information from several other network elements and transmit the stored information to the network topology discovery engine for storage in a database. In this embodiment, the topology discovery engine requests information from a small portion of the entire network to receive information for the entire network, as such information is already gathered by the network elements on their neighboring elements. In either case, the gathered information is retrieved by the topology discovery engine and stored in a network topology or service image database that describes the topology and elements of the telecommunications network. Such information may be utilized by the network or an administrator of the network for various purposes, such as for providing various versions of particular instances of a deployed product in a user interface for network maintenance. Other details of a topology discovery engine to populate the information in the service image database are disclosed in co-filed United States patent application Attorney Docket No. 0415-US-01 to E. Urdang, filed on ______, the entirety of which is incorporated herein.

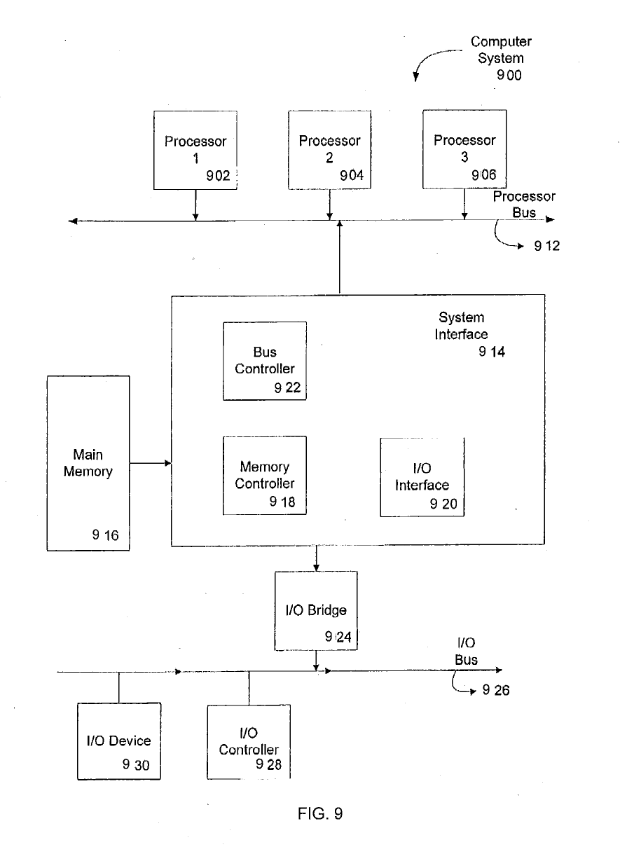

FIG. 9 is a block diagram illustrating an example of a network topology engine, an obsolescence tracker or similar computer system 900 which may be used in implementing embodiments of the present disclosure. The computer system (system) includes one or more processors 902-906. Processors 902-906 may include one or more internal levels of cache (not shown) and a bus controller or bus interface unit to direct interaction with the processor bus 912. Processor bus 912, also known as the host bus or the front side bus, may be used to couple the processors 902-906 with the system interface 914. System interface 914 may be connected to the processor bus 912 to interface other components of the system 900 with the processor bus 912. For example, system interface 914 may include a memory controller 918 for interfacing a main memory 916 with the processor bus 912. The main memory 916 typically includes one or more memory cards and a control circuit (not shown). System interface 914 may also include an input/output (I/O) interface 920 to interface one or more I/O bridges or I/O devices with the processor bus 912. One or more I/O controllers and/or I/O devices may be connected with the I/O bus 926, such as I/O controller 928 and I/O device 930, as illustrated.

I/O device 930 may also include an input device (not shown), such as an alphanumeric input device, including alphanumeric and other keys for communicating information and/or command selections to the processors 902-906. Another type of user input device includes cursor control, such as a mouse, a trackball, or cursor direction keys for communicating direction information and command selections to the processors 902-906 and for controlling cursor movement on the display device.

System 900 may include a dynamic storage device, referred to as main memory 916, or a random access memory (RAM) or other computer-readable devices coupled to the processor bus 912 for storing information and instructions to be executed by the processors 902-906. Main memory 916 also may be used for storing temporary variables or other intermediate information during execution of instructions by the processors 902-906. System 900 may include a read only memory (ROM) and/or other static storage device coupled to the processor bus 912 for storing static information and instructions for the processors 902-906. The system set forth in FIG. 9 is but one possible example of a computer system that may employ or be configured in accordance with aspects of the present disclosure.

According to one embodiment, the above techniques may be performed by computer system 900 in response to processor 904 executing one or more sequences of one or more instructions contained in main memory 916. These instructions may be read into main memory 916 from another machine-readable medium, such as a storage device. Execution of the sequences of instructions contained in main memory 916 may cause processors 902-906 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 916. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It should be noted that the flowcharts of FIGS. 5, 7 and 8 are illustrative only. Alternative embodiments of the present disclosure may add operations, omit operations, or change the order of operations without affecting the spirit and scope of the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present invention. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A method for maintaining information of a telecommunications network, the method comprising:
obtaining information for a first new product comprising a plurality of telecommunication devices, the information for the first new product comprising at least a first list of the plurality of telecommunication devices and a first description of at least one connection between the plurality of telecommunication devices;
comparing the information for the first new product to at least one entry in a product catalogue database configured to store a list of telecommunications products;
creating a product version entry in the product catalogue database, the product version entry comprising the information for the first new product and an indicator indicating that the product version entry is a version of the at least one entry in the product catalogue database; and
displaying the product version entry in a user interface on a computing device.

2. The method of claim 1 further comprising:
obtaining information for a second new product comprising a plurality of telecommunication devices, the information for the second new product comprising at least a second list of the plurality of telecommunication devices and a second description of at least one connection between the plurality of telecommunication devices;
creating a new product entry in the product catalogue database, the new product entry comprising the information for the second new product; and
displaying the new product entry in the user interface on the computing device.

3. The method of claim 1 wherein the user interface comprises a graphical representation of the first list of the plurality of telecommunication devices and the first description of at least one connection between the plurality of telecommunication devices.

4. The method of claim 3 wherein the user interface further comprises a graphical representation of one or more differences between the information for the first new product and the at least one entry in a product catalogue database.

5. The method of claim 1 further comprising displaying the at least one entry in the user interface on a computing device.

6. The method of claim 5 wherein the user interface comprises a user-controllable selection interface configured to be controlled through an input device to the computing device to select between displaying the at least one entry and the new product entry in the user interface.

7. The method of claim 6 wherein the user-controllable selection interface comprises a slide bar and slider controllable through the input device and an information field comprising at least an availability date associated with the at least one entry and the new product entry.

8. The method of claim 1 wherein the at least one entry in the product catalogue comprises an existing product list of a plurality of telecommunication devices and an existing product description of at least one connection between the plurality of telecommunication devices in the existing product list, and wherein the comparing operation comprises:
matching the first list of the plurality of telecommunication devices to the existing product list of the plurality of telecommunication devices; and
matching the first description of at least one connection and the existing product description of at least one connection.

9. A system for maintaining information of a telecommunications network, the system comprising:
a database configured to store topology information for a telecommunications network, the topology information comprising an identification of at least one deployed network element;
a display device;
a processor; and
a computer-readable device associated with the processor and including instructions stored thereon and executable by the processor to:
obtain information for a customer configured product comprising a plurality of telecommunication devices, the information for the customer configured product comprising at least a first list of the plurality of telecommunication devices and a first description of at least one connection between the plurality of telecommunication devices;
creating a customer configured product entry in the database, the customer configured product entry comprising the information for the customer configured product and an indicator indicating the customer associated with the customer configured product entry;
compare the information for the customer configured product to at least one existing entry in the database associated with the customer; and
display the information for a customer configured product in a user interface on the display device.

10. The system of claim 9 wherein the user interface comprises a graphical representation of the first list of the plurality of telecommunication devices and the first description of at least one connection between the plurality of telecommunication devices.

11. The system of claim 10 wherein the user interface further comprises a graphical representation of one or more differences between the information for the customer configured product and the at least one existing entry in the database.

12. The system of claim 9 further comprising an input device configured to select one or more aspects of the user interface on the display device.

13. The system of claim 12 wherein the instructions are further executable by the processor to display the at least one existing entry in the user interface on a display device and wherein the user interface further comprises a user-controllable selection interface configured to be controlled through the input device to select between displaying the at least one existing entry and the customer configured product in the user interface.

14. The system of claim 9 further comprising:
a topology discovery engine module configured to:
transmit a request to the at least one deployed network element, the request configured to request topology information of the at least one deployed network element, the topology information comprising an identification of the at least one network element;
receive the operational topology information of the at least one deployed network element; and
store the operational topology information of the at least one deployed network element in the database.

15. The system of claim 14 wherein the topology discovery engine module is further configured to:
receive operational attributes for a second network element from the first network element in response to the request, the second network element connected to the first network element; and
storing the operational attributes for the second network element in the network topology database, wherein the operational attributes include at least an identification of second network element and a description of a connection between the first network element and the second network element.

16. The method of claim 15 wherein the second network element is an unaddressable network element.

17. The method of claim 15 wherein the operational attributes for the second network element includes an address for communicating with the second network element.

18. The system of claim 15 wherein the topology discovery engine module is further configured to:
receive operational attributes for a third network element from the first network element in response to the request, the third network element connected to the second network element; and
storing the operational attributes for the third network element in the network topology database, wherein the operational attributes include at least an identification of third network element and a description of a connection between the third network element and the second network element.
